(19) United States
(12) Patent Application Publication
(10) Pub. No.: US 2020/0359646 A1
(43) Pub. Date: Nov. 19, 2020

(54) BEVERAGE PRECURSOR, METHOD OF MAKING BEVERAGE PRECURSOR, BEVERAGE, AND METHOD OF MAKING BEVERAGE

(71) Applicant: Kraft Foods Group Brands LLC, Chicago, IL (US)

(72) Inventors: Julie Anne Grover, Burlington, WI (US); Judith Gulten Moca, Palatine, IL (US)

(21) Appl. No.: 16/415,776

(22) Filed: May 17, 2019

(51) Int. Cl. A23F 5/40; A23F 5/42

(52) U.S. Cl. CPC A23F 5/40; B65D 85/8043; A23F 5/42

(57) ABSTRACT

A beverage precursor can include agglomerated particles including a coffee component, a dairy component, and a sweetener. A beverage capsule configured for use in a brew-on-demand beverage apparatus can contain a beverage precursor. A method of making a beverage can include contacting a beverage precursor with water or another liquid.

### FIELD

The present disclosure relates generally to beverage precursors, methods of making such precursors, capsules and cartridges for making beverages, beverages, and methods of making beverages.

### BACKGROUND

Beverages, such as coffee-based beverages, are popular among consumers and are commonly made and served in restaurants, coffee shops, gas stations, convenient stores, in the workplace, etc. The advent of brew-on-demand beverage systems, such as Keurig® K-cups and machines, has increased the flexibility of when and how beverages can be made. These systems allow a user to create a single beverage at any time, on-demand. Also, the systems allow different types of beverages to be made in a short period of time, without having to clean beverage making-equipment between preparation of each beverage. A wide variety of beverages such as coffees, teas, indulgencies such as hot cocoa, etc. are available for use in brew-on-demand beverage systems.

Many popular coffee beverages are supplemented with dairy products such as milk or cream, but providing both in a single brew-on-demand cartridge has posed problems, including lack of adequate shelf life, failure to achieve consistent dissolution of components, excessive foaming, and a variety of brew failures. It is also difficult to provide these types of beverage precursors that make beverages having an acceptable appearance, foaming, mouthfeel, organoleptic properties, etc.

Therefore, it would be desirable to provide beverage precursors including both a coffee component and a high-proportion of a dairy component that can be packaged in a single ready-to-brew container and successfully used to make a beverage having desirable appearance, mouthfeel, organoleptic properties, etc.

### SUMMARY

It has surprisingly been discovered that beverage precursors comprising agglomerated particles including a coffee component, a dairy component, and a sweetener can address problems associated with brew failures, appearance, mouthfeel, organoleptic properties, etc.

In some embodiments, particles of components, such as a coffee component, a dairy component, a sweetener, etc., have similar particle sizes to provide approximate homogeneity across agglomerated particles. In some embodiments, the agglomerated particles further comprise a binder to fix components together until dissolution in water. In some aspects, the agglomerated particles can have branched morphology between particles of different components. In some forms the agglomerated particles can also have a large surface area relative to volume for rapid and effective dissolution of a beverage precursor upon contact with water.

Beverage precursors as discussed herein in some embodiments can be made by agglomerating particles comprising a coffee component, a dairy component, and a sweetener. In some embodiments, beverage precursors according to the present teachings are included in beverage capsules or cartridges configured for use in brew-on-demand beverage apparatuses. A method of making a beverage can include contacting a beverage precursor with water, for instance water heated at a temperature ranging from about 65 to about 108° C., and in some embodiments from about 80 to about 94° C.

### BRIEF DESCRIPTION OF DRAWINGS

FIG. 1 is a photograph of an embodiment of a secondary particle of a beverage precursor;

FIG. 2 is a photograph of an embodiment of a dairy component;

FIG. 3 is a photograph of an embodiment of a beverage made from a beverage precursor not including a sucrose ester; and

FIG. 4 is a photograph of an embodiment of a beverage made from a beverage precursor including a sucrose ester.

### DETAILED DESCRIPTION

Beverages comprising both a coffee component and a dairy component can be prepared from beverage precursors generally including a plurality of agglomerated particles, and in some forms comprise a coffee component, a dairy component, and a sweetener. Coffee, one or more dairy components, one or more sweeteners, and other components can be provided as primary particles within agglomerated particles, i.e. secondary particles. In some embodiments, the agglomerated secondary particles have a microstructure achieved by primary particles of different components having similar particle sizes. In some forms, agglomerated particles can also include at least some primary particles with a branched morphology. This microstructure can provide homogeneity and extended surface area within the agglomerated secondary particles. The structure of the agglomerated particles, including the distribution of primary particles therein, can aid in the rapid and effective dissolution of beverage precursors upon contact with water. Beverage precursors according to the present teachings are useful for inclusion in beverage capsules configured for use in brew-on-demand beverage apparatuses.

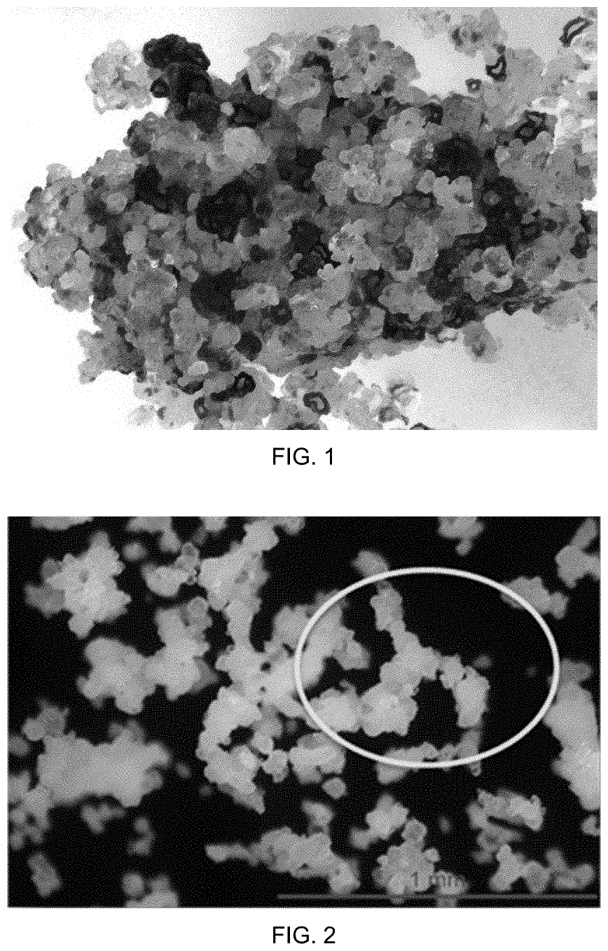

Agglomerated particles can generally comprise any secondary particle size suitable for preparing a beverage. Examples of secondary particles have a D10 of no less than about 30, 45, 60, 75, 90, 105, 120, 135, 150, 165, 180, 195, or 205 microns and a D90 of no greater than about 800, 850, 900, 950, 1000, 1050, 1100. 1150, 1200, 1250, 1300, 1350, 1400, 1450, or 1500 microns. FIG. 1 is a photograph of an embodiment of a secondary particle of a beverage precursor. Agglomerated particles can also generally comprise a mean secondary particle size ranging from about 150 to about 850, about 250 to about 750, about 300 to about 600, about 350 to about 550, or about 400 to about 500 microns. In some aspects, agglomerated secondary particles can further comprise voids, e.g. spaces or pores, between the primary particles. When preparing a beverage from a beverage precursor, the voids can permit transport of water to interiors of the agglomerated particles.

A beverage precursor can generally include a coffee component in any amount suitable for preparing a beverage. Examples of beverage precursors comprise one or more coffee components in a total amount ranging from about 2 to about 55, about 5 to about 45, about 10 to about 40, about 15 to about 35, about 17 to about 34, about 16 to about 32, about 20 to about 30, or about 22 to about 28 wt. % based on a total weight of the beverage precursor. A beverage precursor can generally include a coffee component having any particle size suitable for preparing a beverage. In some preferred forms, coffee components include particles having a D10 of no less than about 130, 125, 120, 115, 110, 100, 95, 90, 85, 80, 75, 70, 65, 60, 55, 50, 45, 40, 35, 30 μm and a D90 of no greater than about 250, 265, 280, 295, 310, 325, 365, 380, 395, 410, 425, 440, 455, 470, 485, 500, 525, 550, 565, 575, 585, 600, 615, 630, 645, 660, 675, 690, or 700 μm. Coffee components can also comprise a mean particle size ranging from about 200 to about 300, about 210 to about 290, about 215 to about 285, about 220 to about 280, about 225 to about 275, about 265 to about 285, or about 240 to about 270 μm.

A coffee component can comprise any of ground coffee, soluble coffee, mixtures thereof, etc. A coffee component can be caffeinated or decaffeinated. Coffee beans can be harvested as the seeds of plants belonging to the plant genus Coffea. A coffee component can be derived from any variety or type of coffee beans or similar matter, or any combination of any varieties and/or types, e.g. Colombian, C. arabica, C. robusta, etc. Prior to making a coffee component, coffee beans are preferably roasted. Roasts include light, medium-light, medium, medium-dark, dark, and very dark roasts. After roasting, beans can be treated. For example, treatment can increase (or decrease) the level of hydration of the beans. Other treatments can impart beans with any desired flavors, e.g. hazelnut, vanilla, etc. Beans can be ground by any method such as grinding (e.g. burr grinding or roller grinding), chopping, pounding, etc. In some embodiments, coffee beans can be ground to a desired particle size for use as a coffee component in a beverage precursor. In other embodiments, ground coffee is further processed into soluble coffee by contacting ground coffee with hot water (e.g. by contacting the ground coffee with hot in percolator columns) to produce a coffee extract and then drying the extract to produce a coffee component comprising dried soluble coffee. The extract can generally be dried by any method, such as spray drying, freeze drying, etc. A dried soluble coffee can comprise a spray dried soluble coffee, a freeze dried soluble coffee, and mixtures thereof. A dried soluble coffee can also be further processed to a desired particle size for use in a coffee component in a beverage precursor. In preferred forms, the coffee component does not comprise foaming coffee containing substantial air voids within individual coffee particles.

A beverage precursor can generally include a dairy component in any amount suitable for preparing a beverage. Examples of beverage precursors comprise one or more dairy components in a total amount ranging from about 15 to about 75, about 20 to about 70, about 25 to about 65, about 25 to about 55, about 30 to about 60, about 34 to about 45, about 35 to about 55, about 37 to about 47, or about 40 to about 50 wt. % based on a total weight of the beverage precursor. In some aspects, a beverage precursor comprises a dairy component in an amount exceeding about 50 wt. % based on a total weight of the beverage precursor. Dairy components can generally comprise a cream component, a milk component, a butter component, various dairy substitutes, mixtures thereof, etc. The contents of a dairy component can optionally be dried. A cream component can generally comprise butterfat from milk. A cream component can generally comprise any fat content such as about 10 to about 65, about 12 to about 60, about 15 to about 55, about 20 to about 50, about 25 to about 45, about 30 to about 40 wt. % based on the total weight of a cream before drying. A milk component can generally have any fat content such as about 0 to about 4, about 0.5 to about 3.5, about 1 to about 2 wt. % based on a total weight of a milk before drying. Useful milk components include whole milk, reduced-fat milk, lowfat milk, skim milk, nonfat milk, etc.

A beverage precursor can generally include a dairy component having any particle size suitable for preparing a beverage. Examples of dairy components, such as dairy components comprising those selected from a cream component, a milk component, and mixtures thereof, comprise particles having a D10 of no less than about 5, 10, 15, 20, 25, 30, 35, 40, 45, 50, 55, 60, 65, 70, 75, 80, 85, 90, or 100 μm and a D90 of no greater than about 90, 130, 170, 200, 210, 250, 290, 333, 350, 375, 400, 410, 450, 490, 530, 570, 610, 640, 670, or 710 μm. Dairy components can also comprise a mean particle size ranging from about 80 to about 360, about 90 to about 250, about 110 to about 340, about 150 to about 300, about 170 to about 190, or about 220 to about 275 μm.

In some forms, dairy components may comprise combinations of a milk component (e.g. skim or nonfat milk) and a cream component. In some embodiments, dairy components comprise a cream component in an amount greater than a milk component. For example, useful ratios of cream component to milk component range from about 80:20 to about 20:80, from about 75:25 to about 25:75, from about 70:30 to about 30:70, from about 60:40 to about 40:60, from about 55:45 to about 45:55, or are about 50:50. Examples of dairy components are considered dry and in various embodiments have a moisture content below about 7.0, 5.0, 3.0, 2.0, or 1.0% based on the total weight of the dairy component. In some aspects, dairy components comprise no added sweetener, e.g. no additional sugar other than sugars present in other parts of a dairy component, such as milk and cream. In various embodiments dairy components may comprise a total fat content ranging from about 20 to about 50, about 25 to about 45, about 30 to about 42, or about 35 to about 40 wt. % based on the total weight of the dairy component. In various embodiments dairy components may comprise a total protein content ranging from about 10 to about 25, about 15 to about 20, or about 17 to about 23 wt. % based on the total weight of the dairy component. In some aspects, proteins found in dairy components can generally include caseins and whey proteins. In some forms dairy components may comprise one or more antioxidants such as tocopherols, ascorbyl palmitate, butylated hydroxyanisole, etc. Some examples of dairy components comprise primary particles having similar particle sizes. In some embodiments, primary particles of dairy components include a D10 of no less than about 25 to about 65 μm, a D90 no greater than about 200 to about 400 μm, a D50 (median particle size) of about 80 to about 175 μm, and a mean particle size of about 90 to about 250 μm. In some aspects, primary particles of a dairy component join to form branched structures. For example, the photograph in FIG. 2, taken with a Stereoscope and Differential Interference Contrast (DIC) Light microscopy, shows one example of a dairy component with a circle drawn around dairy particles associated in a branched morphology.

Without intending to be bound by any particular theory, it is thought that dairy components provide a number of useful functions when primary particles aggregate in structures exhibiting a branched morphology. It is thought that branched connections between primary particles of a dairy component allows particles of other components (e.g. a coffee component, a sweetener, etc.) to more evenly agglomerate with the dairy component. This even agglomeration is thought to promote the formation of secondary particles of a beverage precursor comprising a generally homogenous distribution of different components, which then enhances dissolution of the beverage precursor in water by a reducing the likelihood of large groupings of slower dissolving components. Branched agglomeration of primary particles in a dairy component is also thought to promote formation of a branched morphology within agglomerated secondary particles of a beverage precursor. The branched morphology in the secondary particles of a beverage precursor can also promote formation of voids or pores within the secondary particles. The pores or voids can be gaps or spaces between primary particles of the same or different components within a beverage precursor. Voids or pores can permit transport of water into and through the secondary particles of a beverage precursor. It is theorized that the voids or pores allow water contacting the outside of secondary particles of a beverage precursor to also permeate into the secondary particles and dissolve components from both the inside and the outside of the secondary particles. It is also thought that the pores or voids grow in size as dissolution of secondary particles progresses. In some embodiments, a beverage precursor can include different components that have different dissolution rates. For example, a coffee component can have a higher dissolution rate than a dairy component. Again, without wishing to be bound by theory, it is thought that secondary particles of a beverage precursor that include any combination of a branched morphology, an even distribution of different components, and voids or pores can promote relatively even dissolution of various components, when water contacts the beverage precursor. It is also thought that even and rapid dissolution of a beverage precursor can be even further promoted when primary particles of the various different components have similar particle sizes.

A beverage precursor can generally include any amount of a sweetener suitable for preparing a beverage. Examples of beverage precursors comprise one or more sweeteners in a total amount ranging from ranging from about 0 to about 55, about 5 to about 50, about 10 to about 47, about 15 to about 45, about 20 to about 40, about 27 to about 35, about 23 to about 32, about 25 to about 35, or about 20 to about 35 wt. % based on a total weight of the beverage precursor. Examples of sweeteners include any one or more of natural or artificial sweeteners, such as glucose, fructose, sucrose, lactose, mannose, and maltose, fruit sugar, brown sugar, agave nectar, honey, high-fructose corn syrup, and the like, sugar alcohols such as sorbitol, xylitol, mannitol, maltitol, lactitol, erythritol, and the like, aspartame, Acesulfame potassium, Neotame, Stevia leaf extract, monk fruit extract, steviol glycosides, mogrosides, Saccharin, Sucralose, and the like, and mixtures thereof. In some aspects, sweeteners can be ground granulated, powdered (e.g. powdered or confectioners' sugar), laminated, inverted sugar, icing sugar, and the like.

A beverage precursor can generally include a sweetener having any particle size suitable for preparing a beverage. Examples of sweeteners comprise particles having a D10 of no less than about 260, 250, 240, 230, 220, 200, 170, 155, 149, 135, 125, 100, 90, 80, 50, 40, 30, 20, or 10 μm and a D90 of no greater than about 250, 275, 290, 300, 330, 380, 400, 450, 500, 525, 550, 575, 600, or 625 μm. Sweeteners can also comprise a mean particle size ranging from about 180 to about 800, about 200 to about 560, about 210 to about 500, or about 250 to about 350 μm.

Agglomerated particles of a beverage precursor can also comprise additional additives, such as one or more sucrose esters and/or one or more lecithins. Without intending to be bound by any theory it is believed that one or more sucrose esters, lecithins, or combinations thereof can be included in a beverage precursor in an amount useful for providing a beverage precursor having desired foaming characteristics. Examples of beverage precursors comprise an additive selected from a sucrose ester, a lecithin, and mixtures thereof in a total amount ranging from about 0.1 to about 5.0, about 0.2 to about 4.0, about 0.2 to about 3.0, about 0.3 to about 3.5, about 0.4 to about 3.0, about 0.5 to about 2.5, about 0.6 to about 2.0, about 0.7 to about 2.0, about 0.8 to about 1.5, or about 0.9 to about 1.0 wt. % based on a total weight of the beverage precursor. Useful sucrose esters can generally include any one or more of saturated or unsaturated fatty chains such as behenate, laurate, erucate, myristate, oleate, palmitate, stearate, etc. fatty chains. Some useful sucrose esters comprise a mixture of esters comprising stearate and palmitate fatty chains. Examples of sucrose esters have a hydrophilic-lipophilic balance (HLB) ranging from about 5 to about 20, about 6 to about 16, or about 11 to about 15. Embodiments of sucrose esters comprise an ester content ranging from about 5 to about 95, about 10 to about 90, about 20 to about 80, about 30 to about 75, or about 50 to about 70%. In some embodiments, the sucrose ester (sucrose stearate) is Sisterna® SP70 available from Sisterna B.V. Useful lecithins include canola lecithin, soy lecithin, egg lecithin, sunflower lecithin, cottonseed lecithin, animal fat lecithin, and mixtures thereof. In some embodiments, the lecithin is canola lecithin available from Cargill, Inc.

Beverage precursors can generally comprise any useful amounts of components such as antioxidants, diluents, flavorings, preservatives, buffers, stabilizers, emulsifiers, thickeners, anti-caking agents such as silicon dioxide, tricalcium phosphate, etc., flowing agents, colorants, plant extracts, nutraceuticals, vitamins, minerals, aromas, and the like, and mixtures thereof. These components can be agglomerated with particles of other components of a beverage precursor and/or these components can be applied to or otherwise combined with agglomerated particles of a beverage precursor.

Examples of buffers include phosphate salts, sodium bicarbonate, cream of tartar, etc. Buffers can generally be included in any amount such as about 0.5 to about 9, about 3 to about 9, about 3 to about 7, about 4 to about 6, or about 4.5 to about 5.5 wt. % based on a total weight the beverage precursor. Examples of phosphate salts comprise those selected from a sodium phosphate, a potassium phosphate, and mixtures thereof. In some embodiments, a phosphate salt comprises one or more of disodium phosphate, trisodium phosphate dipotassium phosphate, sodium polyphosphate, potassium phosphate, sodium polyphosphate, etc.

Examples of flavorings include any one or more of confectionery flavorings such as cocoa, caramel, malt, honey, etc., herbal flavorings such as hibiscus, basil, etc., spices such as vanilla, cinnamon, cardamom, saffron, etc., tea flavorings such as black, white, green, rooibos, etc., etc. In some embodiments, a beverage precursor comprises a cocoa powder in addition to coffee particles for the making of mocha-type beverages. Cocoa powder can generally be included in any amount ranging from about 1 to about 15, about 2 to about 10, about 1 to about 7, about 2 to about 6, about 3 to about 5, or about 3.5 to about 4.5 wt. % based on a total weight the beverage precursor. In some embodiments, cocoa powder is agglomerated with other particles of a beverage precursor.

In some aspects, methods of making a beverage precursor comprise applying a fluid, e.g. a liquid or gas, to a mass of particles. For example, the fluid can comprise water, a binder solution, steam, etc. Methods making a making a beverage precursor can also comprise drying the mass of particles to form a beverage precursor comprising agglomerated particles. In some aspects, methods of making a beverage precursor can comprise heating a mass of particles to a temperature sufficient to allow particles in the mass of particles to stick together to form agglomerated particles. For example, the heating can be carried out at a temperature above the glass transition temperature of at least one type of particle in a mass of particles, e.g. a coffee component, a dairy component, a sweetener, etc. A mass of particles can also be fluidized when heating the mass of particles.

In some aspects, a mass of particles useful in methods of making a beverage precursor can generally comprise primary and secondary particles of components such as a coffee component, a dairy component, a sweetener, etc. In some aspects, beverage precursors comprising agglomerated particles, as formed by methods of making a beverage precursor, can comprise a coffee component in an amount ranging from about 2 to about 55, about 5 to about 45, about 10 to about 40, about 15 to about 35, about 17 to about 34, about 16 to about 32, about 20 to about 30, or about 22 to about 28 wt. %, a dairy component in an amount ranging from about 15 to about 75, about 20 to about 70, about 25 to about 65, about 25 to about 55, about 30 to about 60, about 34 to about 45, about 35 to about 55, about 37 to about 47, or about 40 to about 50 wt. %, and a sweetener in an amount ranging from about 0 to about 55, about 5 to about 50, about 10 to about 47, about 15 to about 45, about 20 to about 40, about 27 to about 35, about 23 to about 32, about 25 to about 35, or about 20 to about 35 wt. %, all weight percentages being based on a total weight of the beverage precursor. In some aspects, beverage precursors comprising agglomerated particles, as formed by methods of making a beverage precursor, can comprise coffee components including particles having a D10 of no less than about 130, 125, 120, 115, 110, 100, 95, 90, 85, 80, 75, 70, 65, 60, 55, 50, 45, 40, 35, 30 μm, a D90 of no greater than about 250, 265, 280, 295, 310, 325, 365, 380, 395, 410, 425, 440, 455, 470, 485, 500, 525, 550, 565, 575, 585, 600, 615, 630, 645, 660, 675, 690, or 700 μm, and/or a mean particle size ranging from about 200 to about 300, about 210 to about 290, about 215 to about 285, about 220 to about 280, about 225 to about 275, about 265 to about 285, or about 240 to about 270 μm. In some aspects, beverage precursors comprising agglomerated particles, as formed by methods of making a beverage precursor, can comprise dairy components comprising one or more of a cream component and a milk component, comprising particles having a D10 of no less than about 5, 10, 15, 20, 25, 30, 35, 40, 45, 50, 55, 60, 65, 70, 75, 80, 85, 90, or 100 μm, a D90 of no greater than about 90, 130, 170, 200, 210, 250, 290, 333, 350, 375, 400, 410, 450, 490, 530, 570, 610, 640, 670, or 710 and/or a mean particle size ranging from about 80 to about 360, about 90 to about 250, about 110 to about 340, about 150 to about 300, about 170 to about 190, or about 220 to about 275 In some aspects, beverage precursors comprising agglomerated particles, as formed by methods of making a beverage precursor, can comprise sweeteners comprising particles having a D10 of no less than about 260, 250, 240, 230, 220, 200, 170, 155, 149, 135, 125, 100, 90, 80, 50, 40, 30, 20, or 10 μm, a D90 of no greater than about 250, 275, 290, 300, 330, 380, 400, 450, 500, 525, 550, 575, 600, or 625 and/or a mean particle size ranging from about 180 to about 800, about 200 to about 560, about 210 to about 500, or about 250 to about 350

Some embodiments of a method of making a beverage precursor comprise spraying a binder solution including a liquid and a binder on to a mass of particles. A binder solution can generally comprise one or more liquids, e.g. water, and one or more binders such as any one or more of sweeteners, such as sucrose, carbohydrates such as starch, gums, emulsifiers, and the like. A binder can be dissolved, suspended, emulsified, mixed, or combined with a liquid in any manner to form a binder solution. A binder solution can generally include one or more binders that are the same or different from other materials, e.g. a coffee component, a dairy component, a sweetener, etc., present in a mass of particles to which the binder solution is applied. In various embodiments, a binder solution can comprise a dissolved second sweetener that is the same as or different from a sweetener included in a mass of particles to which the binder solution is applied. In some embodiments, a binder in a binder solution can connect together particles of a mass of particles, i.e. to form agglomerated particles, when the binder solution dries after being applied to the mass of particles. After agglomeration, a beverage precursor can generally comprise a binder in any amount suitable to bind particles together in agglomerated particles. In some aspects, a beverage precursor can comprise a binder in an amount ranging from 0.5 to 15, 1 to 15, 3 to 15, 3 to 10, 5 to 8 wt. % based on a total weight of the beverage precursor.

Some embodiments of methods of making a beverage precursor comprise spraying a liquid on to a mass of particles comprising components such as a coffee component, a dairy component, a sweetener, etc. Examples of suitable liquids for such purposes include those capable of adhering to particles, e.g. water and optional other ingredients. In some embodiments, a liquid sprayed onto a mass of particles draws one or more materials, e.g. coffee component, dairy component, sweetener, etc., out of particles to which the liquid is applied. Without intending to be bound by any particular theory, it is thought that when the liquid dries, the material(s) drawn out the particles also dries and connects particles together to form agglomerated particles. In these embodiments, inclusion of a separate binder to hold the particles together, while optional, is often unnecessary because the material(s) drawn out of the particles connects and holds the particles together.

Some embodiments of methods of making a beverage precursor comprise applying a gas or vapor or aerosol, e.g. steam, to a mass of particles. In some embodiments, steam condenses to water upon contact with a mass of particles, and the water draws one or more materials out of the particles. Without intending to be bound by any particular theory, it is thought that when the water dries, the material(s) drawn out of the particles also dries and connects particles together to form agglomerated particles. In these embodiments, inclusion of a separate binder to hold the particles together, while optional, is often unnecessary because the material(s) drawn out of the particles connects and holds the particles together. In some embodiments, steam is used to soften surfaces of particles in a mass of particles. Without intending to be bound by any particular theory, it is thought that these softened particles then adhere together or to other particles in the mass of particles to form agglomerated particles.

In some aspects, methods of making a beverage precursor can comprise forming agglomerated particles by dry agglomeration or non-re-wet processes of agglomeration performed without the use of binding solutions, liquids or gases. For example, these methods can involve the addition of substantially no water and/or steam to a mass of particles being agglomerated. In some embodiments, a small amount of moisture may be present, for example in the atmosphere during agglomeration in order to maintain the hydration level of the mass of particles during agglomeration. In an embodiment of a dry agglomeration process, a mass of particles is heated to a sufficient temperature to allow particles to stick together. For example, a mass of particles can be heated to or above the glass transition temperature of one or more of different types of primary particles.

In some embodiments of a method of making a beverage precursor, a mass of particles can be fluidized when agglomerating particles. Fluidizing a mass of particles can comprise passing a gas, e.g. air, through the mass of particles to create movement of particles relative to one another within the mass of particles. A gas passed through a mass of particles can generally have any useful temperature to fluidize and heat a mass of particles, such as temperatures ranging from 40 to 70, from 45 to 65, from 50 to 60, or from 50 to 52° C. Heat can also be applied to a fluidized mass of particles by means other than a heated gas, e.g. a heated agglomeration vessel, etc. A mass of particles can generally be heated to any useful temperature during agglomeration, such as temperatures ranging from 25 to 50, 30 to 45, or 35 to 39° C. Agglomeration processes can be operated in any useful manner, such on a batch or continuous basis. A batch agglomeration process can generally be operated for any useful duration, such as from 5 to 60, from 10 to 50, from 15 to 45, from 20 to 40, from 25 to 35, or from 30 to 34 minutes.

When it is desirable to apply a binder solution to fluidized particles during agglomeration, the binder solution can be applied at any useful rate, while also avoiding over-wetting of a mass of particles. A binder solution can be applied continuously or intermittently. An intermittently applied binder solution can generally be applied at intervals of any length, such as intervals ranging from 10 seconds to 10 minutes, 30 seconds to 5 minutes, 1 to 3 minutes, 2 to 3 minutes, or 3 to 4 minutes. Also, intervals of spraying a binder solution can generally be repeated any number of times and separate spraying intervals can be of the same or different durations. Generally, a binder solution can be applied at any flow rate sufficient to form agglomerated particles from a given mass of particles.

A dry down agglomeration process can optionally be performed between intervals of spraying a binder solution and/or after stopping application of a binder solution. A dry down agglomeration process can comprise maintaining gas flow and fluidization of particles without application of a liquid, such as a binder solution. A dry down agglomeration process can generally be conducted for any useful period, such as from 10 seconds to 30 minutes, from 30 seconds to 25 minutes, from 1 minute to 20 minutes, from 2 minutes to 15 minutes, or from 3 to 10 minutes. A mass of particles can be shaken after each or a final drying down processing stage to remove fine particles.

In some aspects, a fluidized bed agglomerator can be utilized for fluidizing a mass of particles. An agglomerator can be configured to operate on a batch or continuous basis and can generally have any volume capable of processing a mass of particles or a flow of particles of any size. A Glatt® GPCG agglomerator available from Glatt GmbH is one type of suitable fluidized bed agglomerator.

A method making a beverage from a beverage precursor generally comprises contacting the beverage precursor with a liquid, preferably water. In some embodiments, a beverage can be made by contacting a beverage precursor with water having a temperature ranging from 65 to 110, 75 to 100, 78 to 95, 80 to 94, 65 to 108, or 80 to 105° C. Temperature and the speed with which water is introduced to the precursor may be varied as desired in order to create the desired type of coffee or coffee-type beverage. A beverage can generally be made by contacting a beverage precursor with water using any type of process. A beverage capsule can contain a beverage precursor and the beverage capsule can be configured for use in a brew-on-demand beverage apparatus. In some aspects, a beverage can be made by passing water through a beverage capsule containing a beverage precursor and dispensing a beverage from the beverage capsule. In some embodiments, a method of making a beverage precursor comprises placing a beverage capsule containing a beverage precursor in a brew-on-demand beverage apparatus, contacting the beverage precursor with water, and dispensing a beverage from the brew-on-demand beverage apparatus. In some embodiments, such a beverage capsule may include a filter. A beverage can also be made by pouring or otherwise dispensing water over a beverage precursor held in a filter, placing a beverage precursor and water in a plunger/press apparatus and displacing agglomerated particles of the beverage precursor relative to the water, placing water and a beverage precursor in a percolator apparatus and percolating water through the beverage precursor, etc.

A beverage precursor comprising agglomerated particles can generally be packaged in any manner, such as in bags, boxes, beverage capsules, beverage capsules in boxes or pouches, etc. A beverage precursor can generally be included in any type of beverage capsules such as pods, pouches, bags, packets, discs, etc. A beverage capsule can generally be configured for use in any type of brew-on-demand beverage apparatus. Some embodiments of beverage capsules include rigid or semi-rigid walls, e.g. polymeric walls, that form a cavity for holding a material such as a beverage precursor. A beverage precursor can be placed directly into such a cavity, or optionally, a beverage precursor can be placed in a liquid permeable pouch, packet, etc. that is disposed within the cavity. Examples of beverage capsules for use with the invention include a Keurig® K-cup, Nespresso® capsules, Senseo® pods, Tassimo discs, etc. For example, K-cups are configured for use in Keurig® brew-on-demand beverage apparatuses, such as a Keurig® K-Mini K15 and a Keurig® 2.0 K500; Nespresso® capsules are configured for use in Nespresso® brew-on-demand beverage apparatuses, such as a Nespresso® VertuoPlus; Senseo® pods are configured for use Senseo® brew-on-demand beverage apparatuses, such as a Senseo® Original XL HD7810; Tassimo discs are configured for use Tassimo brew-on-demand beverage apparatuses, such as a Tassimo T20, etc.

### EXAMPLES

The following examples illustrate embodiments of the present teachings.

### Example 1

Three examples of beverage precursors, a Dairy-Forward composition, a Mocha-Style composition, and a Coffee-Forward composition, were prepared as follows.

The particulate components shown in wt. % in Table 1 were placed in a Glatt® GPCG agglomerator. The total mass of the particulate components in each example amounted to 681 grams. The inlet air of the agglomerator was initially set at 55° C. After five minutes of operation at 55° C., the inlet air temperature was decreased to 50-52° C. to achieve a measured product temperature in the range of 35-39° C. A binder solution including 10 wt. % of sucrose in water was then continuously sprayed at a rate of 12.5 mL/min on the fluidized mass of particles in the agglomerator. It was determined that a binder solution flow rate of 14 mL/min overly wetted particles and flow rates below 12.5 mL/min generated particles having unacceptably small sizes. The duration of the period of spraying and the amount of binder solution sprayed are shown in Table 2. After stopping the spraying, the air flow in the agglomerator was maintained for approximately 10 minutes to dry the agglomerated particles. The composition of the agglomerated particles is shown in Table 3. Table 4 shows the mean, D10, Median, and D90 values of primary particles forming the raw particulate components and the agglomerated particles of the final product, as measured using a Horiba LA-950 laser diffraction particle size distribution analyzer with a powder delivery system.

After preparation of the Dairy-Forward, Mocha-Style, and Coffee-Forward beverage precursors, 50 Keurig® filterless K-cups (coffee pods) were filled with Dairy-Forward, 50 filterless K-cups were filled with Mocha-Style, and 50 filterless K-cups were filled with Coffee-Forward. Each K-cup was filled with 14 grams of beverage precursor. Lids were then heat sealed on the K-cups. The K-cups including the beverage precursors were brew tested in a Keurig® K-Mini K15 machine. A brew test was deemed to fail if the machine stopped mid-way through brew cycle resulting in a “short brew.” If the brew cycle was completed, it was considered to have passed the brew test. Table 5 shows that none of the K-cups including the Dairy-Forward, Mocha-Style, and Coffee-Forward beverage precursors failed during the brew test.

TABLE 1
Powder Formulation

| | Dairy- | Mocha- | Coffee- |
|---|---|---|---|
| Ingredient | Forward | Style | Forward |
| Kerry Melocreme 4007TC | 47.0% | 41.0% | 37.0% |
| Granulated Sugar (sucrose) | 30.0% | 32.0% | 23.0% |
| Spray Dried Colombian Coffee | 17.0% | 17.0% | 34.0% |
| Dipotassium Phosphate | 5.0% | 5.0% | 5.0% |
| Sisterna Sucrose Ester SP70 | 1.0% | 1.0% | 1.0% |
| Cocoa Powder | — | 4.0% | — |
| Total | 100.0% | 100.0% | 100.0% |

TABLE 2
Binder Sprayed on During Processing

| | | ~Amount | |
|---|---|---|---|
| Binder | | Sprayed on | ~Sucrose |
| Solution | Minutes | (mL) | (g) |
| 10% Sucrose | 35 | 437.5 | 6.42% |

TABLE 3
Agglomerated Particles (Powder + Binder)

| | Dairy- | Mocha- | Coffee- |
|---|---|---|---|
| Ingredient | Forward | Style | Forward |
| Kerry Melocreme 4007TC | 44.2% | 38.5% | 34.8% |
| Granulated Sugar + | 34.2% | 36.1% | 27.6% |
| Binder (sucrose) | | | |
| Spray Dried | 16.0% | 16.0% | 31.9% |
| Colombian Coffee | | | |
| Dipotassium Phosphate | 4.7% | 4.7% | 4.7% |
| Sisterna Sucrose Ester SP70 | 0.9% | 0.9% | 0.9% |
| Cocoa Powder processed with | — | 3.8% | — |
| alkali | | | |
| Total | 100.0% | 100.0% | 100.0% |

TABLE 4

| | Mean | D10 | D50, | D90 |
|---|---|---|---|---|
| | (μm) | (μm) | Median (μm) | (μm) |
| Kerry Melocreme 4007TC | 188 | 65.2 | 171 | 333 |
| Granulated sugar | 213 | 149 | 206 | 286 |
| Spray Dried Colombian | 272 | 95.7 | 251 | 468 |
| Coffee | | | | |
| Cocoa Powder processed | 146 | 23.5 | 36.5 | 233 |
| with alkali | | | | |
| Dairy-Forward | 401 | 201 | 368 | 643 |
| agglomerated particles | | | | |
| Mocha-Style | 425 | 214 | 393 | 672 |
| agglomerated particles | | | | |
| Coffee-Forward | 391 | 194 | 360 | 625 |
| agglomerated particles | | | | |

TABLE 5

| | Number of Pods | Brew Test |
|---|---|---|
| Dairy-Forward | 50 | Pass |
| Mocha-Style | 50 | Pass |
| Coffee-Forward | 50 | Pass |

### Example 2

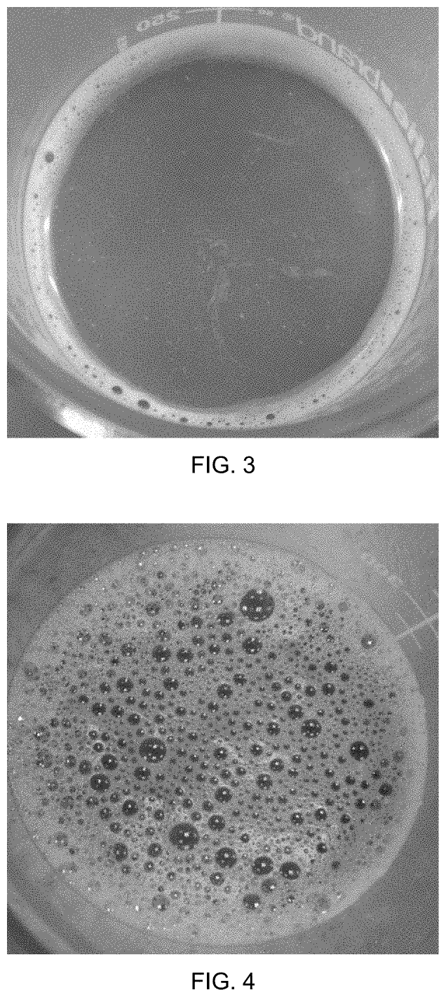

FIGS. 3 and 4 illustrate two different beverages made from different beverage precursors. The beverage shown in FIG. 3 was prepared by filling a first K-cup with 14 grams of a beverage precursor having the composition shown in the second column of Table 6.

TABLE 6

| Ingredient | FIG. 3 | FIG. 4 |
|---|---|---|
| Kerry Melocreme 4007TC | 48.0% | 47.0% |
| Granulated Sugar (sucrose) | 30.0% | 30.0% |
| Spray Dried Colombian Coffee | 17.0% | 17.0% |
| Dipotassium Phosphate | 5.0% | 5.0% |
| Sisterna Sucrose Ester SP70 | | 1.0% |
| Total | 100.0% | 100.0% |

The first K-cup was then placed in a Keurig® 2.0 K500 machine. The machine was started and water was passed through the first K-cup and into a 400 mL beaker. The beverage prepared from the first K-cup is illustrated in FIG. 3.

The beverage shown in FIG. 4 was prepared by filling a second K-cup with 14 grams of a beverage precursor shown in the far right column of Table 6. The beverage illustrated in FIG. 4 was prepared using the second K-cup in the same machine and method used to prepare the beverage in FIG. 3. The beverage in FIG. 4 contained sucrose ester and clearly provided superior foam coverage across the top of the beverage. The foam height in FIG. 4 was 1.0 cm. When left undisturbed, foaming on the beverage in FIG. 4 persisted for 30 minutes after brewing.

### COMPARATIVE EXAMPLES

Comparative beverage precursors (CBP) A-F were prepared from the particulate components shown in wt. % in Table 7. To prepare each of Comparative beverage precursors A-F, the particulate components were placed in a Glatt® GPCG agglomerator and fluidization was initiated. The inlet air of the agglomerator was initially set at the agglomeration temperatures shown in Table 8.

After the fluidized particles in the agglomerator reached 48° C. for CBP A, 46° C. for CBP B, 47° C. for CBP C, 42° C. for CBP D, 42° C. for CBP E, and 50° C. for CBP F, a binder solution was intermittently sprayed on the particles. When preparing Comparative beverage precursors A and B, water was intermittently sprayed on the mass of particles in the agglomerator. When preparing Comparative beverage precursors C and D, a binder solution comprising 10 wt. % of sucrose in water was intermittently sprayed on the mass of particles in the agglomerator. When preparing Comparative beverage precursors E and F, a binder solution comprising 15 wt. % of sucrose in water was intermittently sprayed on the mass of particles in the agglomerator.

The following description describes intermittent application of binder solution and drying in each of Comparative beverage precursors A-F. Binder solution was sprayed on the particles for an initial period of three minutes, followed by one minute of dry down agglomeration without application of binder solution. After the initial dry down, filter bags of the agglomerator were shaken to remove fines. Next, a second application of binder solution was performed for a period of two minutes, followed by one minute of dry down processing and then shaking the particles to remove fines. A third application of binder solution was then performed for two minutes, followed by one minute of dry down processing and then shaking of the particles to remove fines. A final application of binder solution was conducted for two minutes followed by shaking the particles to remove fines and then final dry down processing for three minutes. The total processing time was approximately fifteen minutes.

Table 9 shows the mean D10, Median, and D90 values for the agglomerated particles, as measured using laser diffraction.

After preparation of the Comparative beverage precursors A-F, separate filterless K-cups were each filled with 14 grams of agglomerated particles one of Comparative beverage precursors A-F and a lid was heat-sealed on each K-cup. The K-cups including the Comparative beverage precursors were brew tested in a Keurig® 2.0 K500 machine. A brew test failed if the machine stopped mid-way through brew cycle resulting in a “short brew.” Table 10 shows that each of the K-cups including Comparative beverage precursors A-F failed during the brew test.

TABLE 7
Comparative Beverage Precursors (CBP)-A - F

| | | Batch g |
|---|---|---|
| | % | (1.5 lbs |
| | Powder | total) |
| Granulated Sugar (sucrose) | 32% | 217.92 |
| Spray Dried Colombian Coffee | 17% | 115.77 |
| Blend of Sodium polyphosphate, | 2% | 13.62 |
| disodium phosphate, trisodium phosphate | | |
| 28.5% fat Whole Milk | 49% | 333.69 |
| Powder (WMP) | | |
| TOTAL | 100.0% | 681.00 |

TABLE 8

| | | | Binder Soln. | Binder Soln. | Binder Soln. | Binder Soln. |
|---|---|---|---|---|---|---|
| | | | Flow Rate | Flow Rate | Flow Rate | Flow Rate |
| | | | Interval 1 | Interval 2 | Interval 3 | Interval 4 |
| | Agglomeration | | (t = 0-3 | (t = 4-6 | (t = 7-9 | (t = 10-12 |
| | Temperature | Binder | minutes) | minutes) | minutes) | minutes) |
| CBP A | 70° C. | Water | 25 mL/min | 25 mL/min | 25 mL/min | 25 mL/min |
| CBP B | 90° C. | Water | 25 mL/min | 30 mL/min | 30 mL/min | 30 mL/min |
| CBP C | 70° C. | 10 wt. % | 25 mL/min | 25 mL/min | 25 mL/min | 25 mL/min |
| | | Sucrose | | | | |
| | | in Water | | | | |
| CBP D | 90° C. | 10 wt. % | 25 mL/min | 30 mL/min | 30 mL/min | 30 mL/min |
| | | Sucrose | | | | |
| | | in Water | | | | |
| CBP E | 70° C. | 15 wt. % | 25 mL/min | 25 mL/min | 25 mL/min | 25 mL/min |
| | | Sucrose | | | | |
| | | in Water | | | | |
| CBP F | 90° C. | 15 wt. % | 25 mL/min | 30 mL/min | 30 mL/min | 30 mL/min |
| | | Sucrose | | | | |
| | | in Water | | | | |

TABLE 9

| | Mean | D10 | D50, | D90 |
|---|---|---|---|---|
| | (μm) | (μm) | Median (μm) | (μm) |
| CBP A | 666 | 304 | 665 | 1000 |
| CBP B | 1018 | 505 | 952 | 1606 |
| CBP C | 661 | 306 | 661 | 992 |
| CBP D | 1029 | 445 | 963 | 1686 |
| CBP E | 655 | 241 | 612 | 1119 |
| CBP F | 708 | 293 | 708 | 1082 |

TABLE 10

| | Brew Test |
|---|---|
| CBP A | Fail |
| CBP B | Fail |
| CBP C | Fail |
| CBP D | Fail |
| CBP E | Fail |
| CBP F | Fail |

Without intending to be bound by any particular theory, it is though that Comparative beverage precursors A-F failed in the brew test due to larger particle sizes created by either the selection of dairy components or the intermittent application of liquid when preparing the Comparative beverage precursors. It is also thought that larger particles clog holes in a K-cup, causing undesirable leaking when brewing.

It is thus seen that the present disclosure provides beverage precursors, methods of making such compositions, as well as beverages made from beverage precursors and methods of making such beverages.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. Any description of certain embodiments as “preferred” embodiments, and other recitation of embodiments, features, or ranges as being preferred, or suggestion that such are preferred, is not deemed to be limiting. The invention is deemed to encompass embodiments that are presently deemed to be less preferred and that may be described herein as such. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

What is claimed is:

1. A beverage precursor comprising agglomerated particles comprising a coffee component, a dairy component, and a sweetener, the beverage precursor comprising about 5 wt. % to about 45 wt. % of the coffee component, about 25 wt. % to about 55 wt. % of the dairy component, and about 15 wt. % to about 45 wt. % of the sweetener, all weight percentages being based on a total weight of the beverage precursor.

2. The beverage precursor of claim 1, wherein the coffee component comprises particles having a D10 of about 50 μm to about 130 μm and a D90 of about 250 μm to about 600 the dairy component comprises particles having a D10 of about 25 μm to about 100 μm and a D90 of about 90 μm to about 450 and the sweetener comprises particles having a D10 of about 90 μm to about 260 μm and a D90 of about 250 μm to about 500 μm.

3. The beverage precursor of claim 1, wherein the agglomerated particles have a D10 of about 105 μm to about 205 μm and a D90 of about 800 μm to about 1000 μm.

4. The beverage precursor of claim 1, wherein the agglomerated particles further comprise an additive selected from a sucrose ester, a lecithin, and a mixture thereof, and the beverage precursor comprises the additive in an amount ranging from about 0.2 wt. % to about 3.0 wt. % based on a total weight of the beverage precursor.

5. The beverage precursor of claim 1, wherein the beverage precursor further comprises one or more of canola lecithin, soy lecithin, egg lecithin, sunflower lecithin, cottonseed lecithin, and animal fat lecithin.

6. The beverage precursor of claim 1, wherein the agglomerated particles further comprise a binder, and the beverage precursor comprises the binder in an amount ranging from about 1 wt. % to about 15 wt. % based on a total weight of the beverage precursor.

7. The beverage precursor of claim 6, wherein the agglomerated particles comprise a branched morphology of the binder linking together primary particles of the coffee component, the dairy component, and the sweetener.

8. The beverage precursor of claim 1, wherein the agglomerated particles further comprise voids.

9. The beverage precursor of claim 6, wherein the binder comprises a second sweetener.

10. The beverage precursor of claim 9, wherein the sweetener and the second sweetener are the same.

11. The beverage precursor of claim 1, wherein the sweetener is selected from sucrose, glucose, fructose, lactose, stevia, steviol glycosides, monk fruit, mogrosides, an artificial sweetener, and mixtures thereof.

12. The beverage precursor of claim 9, wherein the second sweetener is selected from sucrose, glucose, fructose, lactose, and mixtures thereof.

13. The beverage precursor of claim 1, wherein the dairy component comprises a cream component and a milk component.

14. The beverage precursor of claim 13, wherein the milk component comprises nonfat or skim milk.

15. The beverage precursor of claim 1, wherein the coffee component comprises a dried soluble coffee.

16. The beverage precursor of claim 15, wherein the dried soluble coffee is selected from a spray dried soluble coffee, a freeze dried soluble coffee, and a mixture thereof.

17. The beverage precursor of claim 1, further comprising a phosphate salt in an amount ranging from about 0.5 wt. % to about 9 wt. % based on a total weight the beverage precursor.

18. The beverage precursor of claim 17, wherein the phosphate salt is selected from a sodium phosphate, a potassium phosphate, and a mixture thereof.

19. The beverage precursor of claim 1, further comprising a cocoa powder in an amount ranging from about 2 wt. % to about 10 wt. % based on a total weight the beverage precursor.

20. The beverage precursor of claim 19, wherein the agglomerated particles further comprise the cocoa powder.
